(19) United States
(12) Patent Application Publication
(10) Pub. No.: US 2022/0290320 A1
(43) Pub. Date: Sep. 15, 2022

(54) METHOD FOR COATING A TURBOMACHINE PART

(71) Applicants: SAFRAN AIRCRAFT ENGINES, PARIS (FR); CENTRE NATIONAL DE LA RECHERCHE SCIENTIFIQUE, PARIS (FR); UNIVERSITE PAUL SABATIER TOULOUSE III, TOULOUSE (FR)

(72) Inventors: Stéphane KNITTEL, MOISSY-CRAMAYEL (FR); Léa Rébecca GANI, MOISSY-CRAMAYEL (FR); Florence ANSART, LABEGE (FR); Romain NOIVILLE, MONTROUGE (FR); Pierre-Louis TABERNA, BAGNERES de LUCHON (FR); Julien WAGNER, MOISSY-CRAMAYEL (FR)

(21) Appl. No.: 17/634,789

(22) PCT Filed: Jul. 30, 2020
(86) PCT No.: PCT/FR2020/051406

§ 371 Date: Feb. 11, 2022

(30) Foreign Application Priority Data
Aug. 12, 2019 (FR) FR1909158

(51) Int. Cl. C25D 13/18; C25D 13/02; C25D 13/12

(52) U.S. Cl. CPC C25D 13/18; C25D 13/02; C25D 13/12; F01D 5/288

(57) ABSTRACT

A method for coating a turbomachine part includes depositing a paint by electrophoresis on the part, a voltage between the part and a counter electrode being controlled during the deposition by imposing a sequence of pulsed voltage cycles, each cycle having: (i) a first voltage stabilization phase during which a first potential difference is imposed between the part and the counter electrode, and a second voltage stabilization phase during which a second potential difference is imposed, an absolute value of the first potential difference being between 0.1 V and 30 V, and an absolute value of the second potential difference being less than the absolute value of the first potential difference, the second potential difference being not equal to zero or being equal to zero, and (ii) a ratio R [duration of the first phase]/[duration of the first phase+duration of the second phase] between 1:10 and 1:3.

### TECHNICAL FIELD

The present invention relates to a method for coating a turbomachine part with a paint, for example an anti-corrosion paint, implementing a step of deposition by electrophoresis.

### PRIOR ART

High-strength steels, such as Managing 250 or ML340, can be used to form turbomachine parts. However, in use, these steels can be sensitive to corrosion. In order to protect the parts from corrosion, it is known to coat them with anti-corrosion paints sprayed using a spray gun. With this type of method, controlling the thickness of applied paint can be relatively delicate, in particular if the part has a complex geometry. Non-compliant coatings having an unsatisfactory corrosion resistance may therefore be obtained.

It is therefore desirable to have a method for depositing a coating, for example an anti-corrosion coating, which makes it possible to obtain, in a simple manner, a coating having the desired properties, for example a satisfactory anti-corrosion protection.

### DISCLOSURE OF THE INVENTION

The invention relates to a method for coating a turbomachine part, comprising:
depositing a paint by electrophoresis on the turbomachine part, the voltage between the part and a counter-electrode being controlled during the deposition by imposing a sequence of pulsed voltage cycles, each of these cycles having:
   (i) a first voltage stabilization phase during which a first potential difference is imposed between the part and the counter electrode, and a second voltage stabilization phase during which a second potential difference is imposed between the part and the counter electrode, the absolute value of the first potential difference being between 0.1 V and 30 V, and the absolute value of the second potential difference being less than the absolute value of the first potential difference, and
   (ii) a ratio R [duration of the first phase]/[duration of the first phase+duration of the second phase] between 1:10 and 1:2.

For conciseness, the expressions “first voltage stabilization phase” and “second voltage stabilization phase” are respectively designated hereinafter by “first phase” and “second phase”, The ratio R [duration of the first phase]/[duration of the first phase+duration of the second phase] will in turn be designated hereinafter by the expression “ratio R”.

Through the use of the pulsed voltage cycles described above, the invention makes it possible to achieve a uniform and dense coating conferring, for example, a satisfactory protection against corrosion. The invention makes it possible, in particular, to avoid the phenomena of “bubbling” of the electrolyte associated with the electrolysis of water which may be encountered when a DC voltage is imposed during electrophoresis. This “bubbling” phenomenon leads to a much less uniform and therefore significantly less efficient coating. The invention is based on the implementation of an electrophoresis technique with specific electrical parameters, which enables the desired coating to be obtained in a simple manner. The electrophoresis technique implemented in the invention also provides better control of the thickness of the coating deposited in comparison to spraying using a spray gun. It is thus of particular interest for coating parts having a complex geometry.

In an embodiment, the absolute value of the first potential difference is less than or equal to 15 V.

The use of a first potential difference with limited absolute value makes it possible to further improve the uniformity of the obtained coating.

In particular, the absolute value of the first potential difference may be less than or equal to 10 V, for example less than or equal to 7 V. The absolute value of the first potential difference can be between 2 V and 15 V, for example between 2 V and 10 V, for example between 5 V and 10 V, for example between 5 V and 7 V or between 2 V and 7 V.

In an embodiment, the absolute value of the second potential difference is less than or equal to 5 V.

The use of a second potential difference with limited absolute value makes it possible to further improve the uniformity of the obtained coating.

In an embodiment, the ratio R is between 1:10 and 1:3.

The use of these values for the ratio R makes it possible to further improve the uniformity of the coating obtained.

In particular, the ratio R can be between 1:10 and 1:4. The ratio R can also be between 1:6 and 1:3 or between 1:6 and 1:4.

In an embodiment, the pulsed voltage cycles are repeated with a frequency less than or equal to 1 kHz during the deposition by electrophoresis.

The fact of limiting the frequency of repetition of the pulsed voltage cycles is advantageous in order to increase the relaxation time of the system between two successive first phases, which enables the uniformity of the coating obtained to be further improved.

In particular, said frequency can be less than or equal to 100 Hz, or even less than or equal to 10 Hz.

In an embodiment, the paint is inorganic.

The use of an inorganic paint is advantageous when the turbomachine part is intended to operate at relatively high temperatures, outside of the stability range for organic paints.

In an embodiment, the paint is an anti-corrosion paint.

In an embodiment, the part is an aircraft turbomachine part.

### BRIEF DESCRIPTION OF THE FIGURES

FIG. 1 shows schematically and in part the implementation of a method according to the invention.

FIG. 2 shows schematically and in part the implementation of a method according to the invention,

FIG. 3 shows an example sequence of pulsed voltage cycles that can be implemented within the scope of the invention.

FIG. 4 shows an example sequence of pulsed voltage cycles that can be implemented within the scope of the invention.

FIG. 5 represents, schematically, a turbomachine blade that can be coated by the method according to the invention,

FIG. 6 is a photograph showing the coating obtained within the scope of a method according to the invention.

FIG. 7 is a photograph showing the coating obtained within the scope of a method not according to the invention.

FIG. 8 is a photograph showing the coating obtained within the scope of a method according to the invention.

FIG. 9 is a photograph showing the coating obtained within the scope of a icy method according to the invention.

FIG. 10 is a photograph showing the coating obtained within the scope of a method according to the invention.

FIG. 11 is a photograph showing the coating obtained within the scope of a method according to the invention.

FIG. 12 is a photograph showing the coating obtained within the scope of a method according to the invention.

FIG. 13 is a photograph showing the coating obtained within the scope of a method according to the invention.

FIG. 14 is a photograph showing the coating obtained within the scope of a method according to the invention.

FIG. 15 is a photograph showing the coating obtained within the scope of a method according to the invention.

FIG. 16 is a photograph showing the coating obtained within the scope of a method according to the invention.

FIG. 17 is a photograph showing the coating obtained within the scope of a method according to the invention.

### DESCRIPTION OF THE EMBODIMENTS

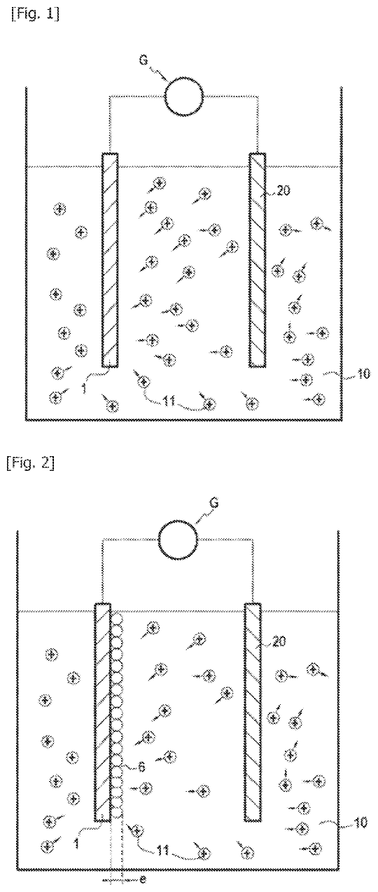

With reference to FIGS. 1 and 2, the part 1 to be coated is immersed in a bath of a paint 10 which is, for example, an anti-corrosion paint. The surface of the part 1 intended to be coated by the paint can have been prepared beforehand in conventional manner by a chemical and/or mechanical pickling step.

The surface of the part 1 intended to be coated comprises an electrically conductive material. The part 1 can be made of a metal material, for example aluminum or an aluminum alloy, steel or a nickel- or cobalt-based superalloy. The part 1 may be an aircraft turbomachine part. The part 1 may be a turbomachine blade, such as a turbine blade or a compressor blade, a turbine shaft or a portion of a turbine shaft, a compressor shaft for a portion of a compressor shaft.

The part 1 constitutes an electrode which is connected to a first terminal of a voltage generator G. A counter electrode 20 is present facing the surface of the part 1 to be coated and is also immersed in the bath of paint 10. The counter electrode 20 is connected to a second terminal of the voltage generator G, different from the first terminal.

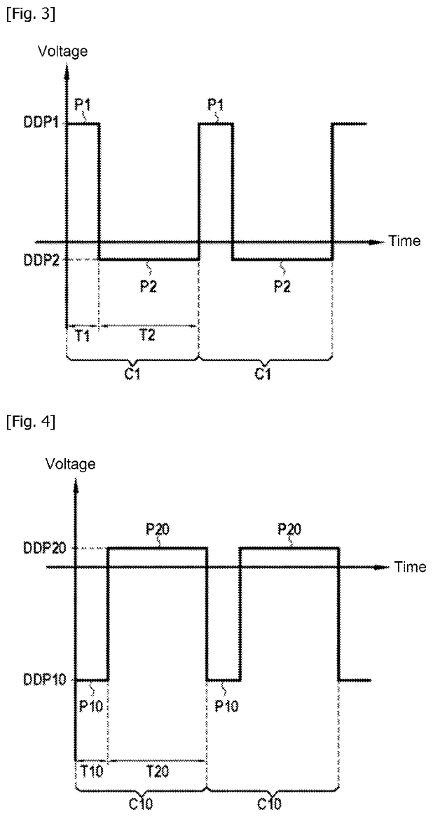

During the deposition by electrophoresis, the generator G imposes specific pulsed voltage cycles between the part 1 and the counter electrode 20 which are described in more detail in the following, with reference to FIGS. 3 and 4. A stirring means (not shown) may be present in the paint bath 10 in order to ensure mixing of this bath during the deposition.

A commercial paint 10 that is known per se can be used. The paint 10 is typically in the form of a suspension comprising solid particles 11 dispersed in a liquid medium. Advantageously, the paint 10 can be devoid of chromium in oxidation state +VI in order to be compatible with the regulations on “Registration, Evaluation, Authorization and Restriction of Chemicals” (“REACH”). The paint 10 can contain chromium in oxidation state +III. An example of usable paint 10 is the paint marketed by PRAXAIR under the name SERMETEL W®.

The particles 11 of the paint 10 can comprise one or more pigments, for example one or more anti-corrosion pigments in the case of an anti-corrosion paint. These pigments are typically chosen from: metal phosphates, for example zinc phosphate; metal chromates, such as magnesium chromate; or halogen-zirconates; or the mixtures of such compounds. Electrically conductive particles, such as aluminum particles, can be added to the pigment or pigments. The addition of these conductive particles makes it possible to give the layer 6 an electrically conductive nature, which makes it possible to avoid a self-limiting effect of the deposition by electrophoresis and makes it possible, if desired, to deposit a relatively thick layer 6.

In the case where such conductive particles are not present, the treated surface can become gradually more and more insulating during the deposition of the layer 6, naturally slowing, or even stopping, its formation. By way of illustration, the thickness e of the deposited layer 6 can be greater than or equal to 35 μm, for example between 35 μm and 70 μm.

By way of illustration, the average size D50 of, possibly agglomerated, particles 11 of the paint 10 can be less than or equal to 10 μm, for example between 0.1 μm and 10 μm. The liquid medium of the paint can typically contain a binder and a solvent. The paint 10 may optionally further comprise one or more additives for adjusting its properties, such is its viscosity or the stability of the suspension.

During the deposition, the generator G imposes a variable potential difference between the part 1 and the counter electrode 20. Due to the application of an electric field between the part 1 and the counter electrode 20, the electrically charged paint particles 11 move and are deposited on the part 1 in order to obtain the layer 6. The example illustrated in FIGS. 1 and 2 concerns the case where the part 1 is negatively charged during the first phases of the voltage cycles, the particles 11 themselves being positively charged. The particles 11 are thus deposited on the part 1 during the first phases of the voltage cycles. However, it does not depart from the scope of the invention if the part 1 is positively charged during the first phases of the voltage cycles and the particles negatively charged. By way of illustration, when the particles 11 are positively charged, they may have a zeta potential greater than or equal to 1 mV, for example greater than or equal to 10 mV. The zeta potential of the particles 11 can typically be between 1 mV and 100 mV, for example between 10 mV and 30 mV.

The preceding description has attempted to describe the electrophoresis system and the formation of the layer 6 with reference to FIGS. 1 and 2. FIGS. 3 and 4, which illustrate examples of pulsed voltage cycles that can be implemented within the scope of the invention, will now be described.

According to the example of FIG. 3, each voltage cycle C1 comprises a first voltage stabilization phase P1 during which a first constant potential difference DDP1 is imposed between the part 1 and the counter electrode 20. Unless otherwise mentioned, the potential differences correspond to the following different: [(electrical potential of the part 1)−(electrical potential of the counter electrode 20)]. The first potential difference DDP1 is between 0.1 V and 30 V, for example between 5 V and 7 V. FIG. 3 concerns the case where the part 1 is positively charged during the first phases P1 to a potential greater than that of the counter electrode 20; however, it does not depart from the scope of the invention when the part is negatively charged during these phases as illustrated in FIG. 4 which will be discussed below. Each voltage cycle C1 further comprises a second voltage stabilization phase P2 during which a second constant potential difference DDP2 is imposed between the part 1 and the counter electrode 20. Each voltage cycle C1 comprises a single first phase P1 and a single second phase P2. The absolute value of the second potential difference DDP2 is less than the first potential difference DDP1. The absolute value of the second potential difference DDP2 may be less than or equal to half the first potential difference DDP1. The absolute value of the second potential difference DDP2 may be less than or equal to 5 V. In the example illustrated in FIG. 3, the case is shown of a second potential difference DDP2. This case corresponds to the application of an alternating voltage between the part 1 and the counter electrode 20 during the deposition by electrophoresis. As an alternative, it is possible to have a zero or positive potential difference DDP2.

During the deposition by electrophoresis, there is an alternation between the first voltage stabilization phases P1 and the second voltage stabilization phases P2. Hence, there is, successively: performance of a first voltage stabilization phase P1 of a first cycle, then a second voltage stabilization phase P2 of this first cycle, then performance of a first voltage stabilization phase P1 of a second cycle, then a second voltage stabilization phase P2 of this second cycle and so on.

As indicated above, the relative durations of the first phases P1 and the second phases P2 are controlled within the scope of the invention. Hence, for each pulsed voltage cycle C1, the ratio R, which corresponds to the ratio T1/[T1+T2], is fixed at a predetermined value between 1:10 and 1:2, where T1 designates the duration of the first phase P1 and T2 the duration of the second phase P2. The ratio R is, for example, between 1:6 and 1:4.

The pulsed voltage cycles C1 can be repeated periodically during the deposition by electrophoresis, as illustrated. The frequency of repetition of the pulsed voltage cycles can be less than or equal to 1 kHz, for example less than or equal to 100 Hz, for example less than or equal to 5 Hz. This frequency can be between 0.1 Hz and 1 kHz, for example between 0.1 Hz and 100 Hz, for example between 1 Hz and 100 Hz, for example between 1 Hz and 10 Hz, or even between 1 Hz and 5 Hz. The pulsed voltage cycles C1 can be applied for a duration greater than or equal to 1 minute. This duration can be less than or equal to 30 minutes, for example less than or equal to 10 minutes. This duration can be between 1 minute and 30 minutes, for example between 1 minute and 10 minutes.

FIG. 4 shows a variant in which the part is negatively charged during the first voltage stabilization phases P10. Hence, in this case, each voltage cycle C10 comprises a first voltage stabilization phase P10 during which a first constant potential difference DDP10 is imposed between the part 1 and the counter electrode 20. The absolute value of the potential difference DDP10 satisfies the values indicated above. Each voltage cycle C10 further comprises a second voltage stabilization phase P20 during which a second constant potential difference DDP20 is imposed between the part 1 and the counter electrode 20. This second potential difference DDP20 satisfies the conditions mentioned above. In the example of FIG. 4, the case is shown of a positive second potential difference DDP20 but it does not depart from the scope of the invention if DDP20 is zero or negative. The durations T10 and T20 of the stabilization phases P10 and P20 satisfy the same ratio condition with respect to T1 and T2.

In general, the ratio R can vary between 1:10 and 1:2. It will be noted that for relatively high values of R, close to 1:2, it may be preferable to use first potential differences that are limited in absolute value, in order to improve the uniformity of the layer formed.

The method of the invention can be implemented for coating a turbomachine blade 21 having, for example, a root 22, an airfoil 24 and a head 26, as illustrated highly schematically in FIG. 5. The invention applies, of course, to other types of turbomachine parts, such as those listed above, for example.

### EXAMPLES

### Example

An anti-corrosion paint was deposited using an electrophoresis system with two electrodes, comprising a platinum electrode and a 15CDV6 steel electrode. The deposited anti-corrosion paint was the paint marketed by PRAXAIR under the name SERMETEL W®.

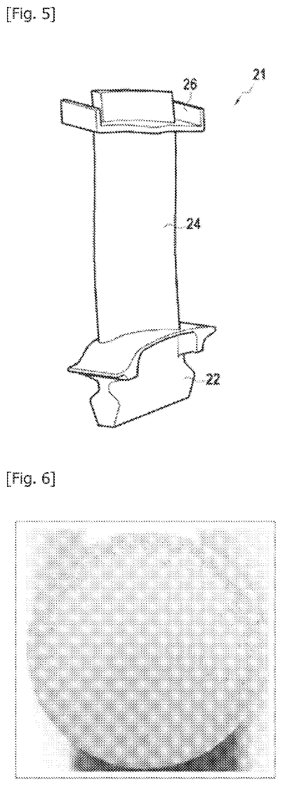

A first test according to the invention was carried out by imposing a sequence of post-voltage cycles, each pulsed voltage cycle had a positive first voltage stabilization phase at 10 V and a second voltage stabilization phase at 0 V. The part icy to be coated was positively charged during the first phases. Each pulsed voltage cycle had a ratio R of 1:3. The voltage cycles were repeated at a frequency of 1 Hz and the deposition by electrophoresis was performed for a duration of 5 minutes. FIG. 6 is a photograph showing the appearance of the coating obtained.

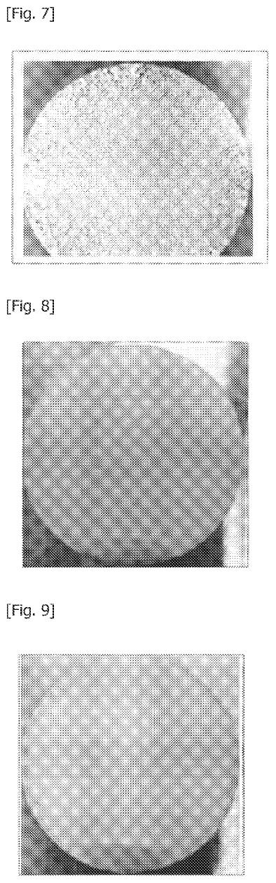

By way of comparison, a second test outside of the scope of the invention was performed with the same electrophoresis system but by imposing a DC voltage at 10 V for a period of 1 minute 40 seconds (no alternation with second phases at zero voltage). This duration of 1 minute 40 seconds corresponds to the accumulated duration of application of the voltage of 10 V during the first test (=5 minutes/3). FIG. 7 is a photograph showing the appearance of the coating obtained.

It can be seen that the deposition associated with FIG. 7 is much less uniform than that associated with FIG. 6. More specifically, there was a “bubbling” phenomenon during the DC voltage deposition of FIG. 7, which has led to a non-uniform coating.

### Example 2

Additional tests were carried out using the same electrophoresis system as in example 1 and by using the same sequence of pulsed voltage cycles as in the first test described in example 1 with the exception of the ratio R which was modified. FIG. 8 is a photograph showing the appearance of the coating obtained for a ratio R of 1:6 (coating thickness=43 μm). FIG. 9 shows the result obtained for a ratio R of 1:4 (coating thickness=31 μm).

In these two cases, a particularly uniform anti-corrosion deposition was obtained, having an even better uniformity compared to that of the first test of example 1 using a ratio R of 1:3.

### Example 3

Additional tests were carried out using the same electrophoresis system as in example 1 and by using the same sequence of pulsed voltage cycles as in the first test described in example 1 with the exception of the value of the voltage of the first phases which was modified.

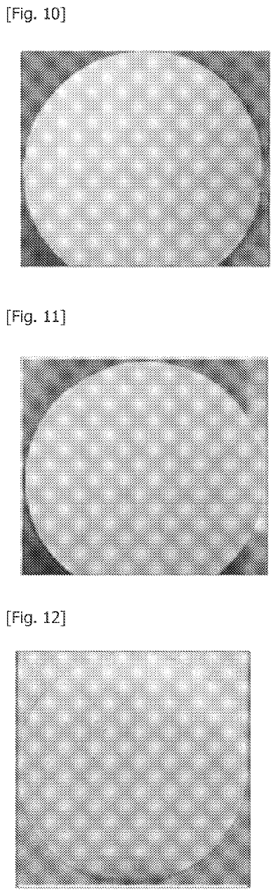

FIG. 10 is a photograph showing the appearance of the coating obtained for a voltage of 7 V during the first phases (coating thickness=23 μm). FIG. 11 shows the result obtained when this voltage is 5 V (coating thickness=28 μm).

In these two cases, a particularly uniform anti-corrosion deposition was obtained, having an even better uniformity compared to that of the first test of example 1 using a voltage of 10 V during the first phases.

### Example 4

Additional tests were carried out using the same electrophoresis system as in example 1 and by using the same sequence of pulsed voltage cycles as in the first test described in example 1 with the exception of the value of the voltage of the second phases which was modified.

FIG. 12 is a photograph showing the appearance of the coating obtained for a voltage of −2 V during the second phases (coating thickness=38 μm).

In this case, a particularly uniform anti-corrosion deposition was obtained, having an even better uniformity compared to that of the first test of example 1 using a voltage of 0 V during the second phases.

### Example 5

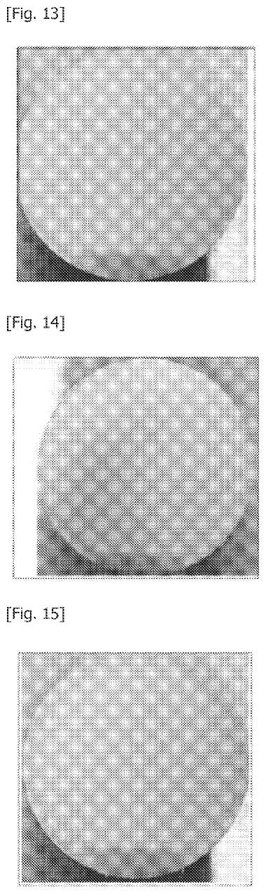

Additional tests were carried out using the same electrophoresis system as in example 1 and by using the same sequence of pulsed voltage cycles as in the first test described in example 1 with the exception of the duration of the deposition by electrophoresis which was fixed at 1 minute. Several voltage values of the first phases were evaluated with this treatment duration, namely: 10 V (FIG. 13, coating thickness=43 μm), 12 V (FIG. 14, coating thickness=31 μm) and 15 V (FIG. 15, coating thickness=28 μm).

In all cases, it was observed that an anti-corrosion deposition having good uniformity was obtained.

### Example 6

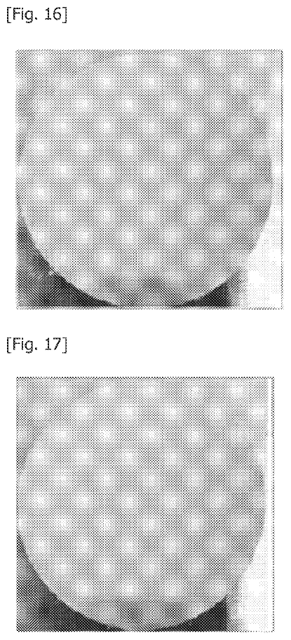

Additional tests were carried out using the same electrophoresis system as in example 1 and by using the same sequence of pulsed voltage cycles as in the first test described in example 1 with the exception of the duration of the deposition by electrophoresis which was fixed at 1 minute and of the frequency which was modified. FIG. 16 shows the results obtained for a repetition frequency of the cycles of 2 Hz (coating thickness=26 μm) and FIG. 17 shows the results obtained for a repetition frequency of the cycles of 5 Hz (coating thickness=31 μm).

In all cases, it was observed that an anti-corrosion deposition having good uniformity was obtained.

The expression “between . . . and . . . ” should be understood as including the limits.

1. Method for coating a turbomachine part, comprising:
depositing a paint by electrophoresis on the turbomachine part, a voltage between the part and a counter electrode being controlled during the deposition by imposing a sequence of pulsed voltage cycles, each of the pulsed voltage cycles having:
(i) a first voltage stabilization phase during which a first potential difference is imposed between the part and the counter electrode, and a second voltage stabilization phase during which a second potential difference is imposed between the part and the counter electrode, an absolute value of the first potential difference being between 0.1 V and 30 V, and an absolute value of the second potential difference being less than the absolute value of the first potential difference, the second potential difference being not equal to zero or being equal to zero, and
(ii) a ratio R [duration of the first phase]/[duration of the first phase+duration of the second phase] between 1:10 and 1:3.

2. The method according to claim 1, wherein the absolute value of the first potential difference is less than or equal to 15 V.

3. The method according to claim 2, wherein the absolute value of the first potential difference is less than or equal to 10 V.

4. The method according to claim 3, wherein the absolute value of the first potential difference is less than or equal to 7 V.

5. The method according to claim 1, wherein the absolute value of the second potential difference is less than or equal to 5 V.

6. (canceled)

7. The method according to claim 5, wherein the ratio R is between 1:10 and 1:4.

8. The method according to claim 1, wherein the pulsed voltage cycles are repeated with a frequency less than or equal to 1 kHz during the deposition by electrophoresis.

9. The method according to claim 8, wherein said frequency is less than or equal to 100 Hz.

10. The method according to claim 1, wherein the paint is inorganic.

11. The method according to claim 1, wherein the paint is an anti-corrosion paint.

12. The method according to claim 1, wherein the part is an aircraft turbomachine part.
